(19) United States
(12) Patent Application Publication
(10) Pub. No.: US 2020/0163322 A1
(43) Pub. Date: May 28, 2020

(54) ADHESIVE BARRIER FOR CRAWLING INSECTS

(71) Applicant: GARDEN HUNTER SOLUTIONS INC., Abbotsford (CA)

(72) Inventor: Randall Sanford, Abbotsford (CA)

(73) Assignee: GARDEN HUNTER SOLUTIONS INC., Abbotsford (CA)

(21) Appl. No.: 16/694,771

(22) Filed: Nov. 25, 2019

Related U.S. Application Data
(60) Provisional application No. 62/771,541, filed on Nov. 26, 2018.

(51) Int. Cl. A01M 1/14

(52) U.S. Cl. CPC A01M 1/14; A01M 2200/011

(57) ABSTRACT

There is disclosed an adhesive barrier for crawling insects, comprising a flexible sheet of material having an adhesive on at least one side, with a peel-off liner protecting the adhesive surface. The flexible sheet of material is shaped to form a self-standing adhesive barrier when its first and second side edges are overlapped and bonded together, the self-standing barrier having angled side walls and first and second openings of a different size, at least one of the first and second openings adapted to be placed on a flat surface without any gaps. In an embodiment, the flexible sheet forms a self-standing adhesive barrier in the shape of a cone, with a large opening at one end, and a smaller opening at the other end. At least one opening is adapted to be placed on a flat surface without any gaps.

### FIELD OF THE INVENTION

The present invention relates generally to crawling insect traps and barriers.

### BACKGROUND

Adhesive pads or sheets may be used to trap insects by proving a very sticky surface to immobilize insects that come in contact with them. Typically, these adhesive pads or sheets are laid flat on a surface of an insect trap, or are otherwise affixed on a vertically oriented surface to present a barrier for crawling insects.

What is needed is a simple, practical way to set up an insect barrier without any additional apparatus required.

### SUMMARY

The present invention relates to an adhesive barrier for crawling insects which can be set up without any additional apparatus.

In an embodiment, the adhesive barrier comprises a flexible sheet of material having an adhesive on at least one side, with a peel-off liner protecting the adhesive surface. The flexible sheet of material is shaped to form a self-standing adhesive barrier when its first and second side edges are overlapped and bonded together, the self-standing barrier having angled side walls and first and second openings of a different size, at least one of the first and second openings adapted to be placed on a flat surface without any gaps.

In an embodiment, the flexible sheet forms a self-standing adhesive barrier in the shape of a cone, with a large opening at one end, and a smaller opening at the other end. At least one opening is adapted to be placed on a flat surface without any gaps.

In an embodiment, the adhesive barrier is a flat, flexible, partial band or ring shape forming an arc. For example, the shape may be described as half of a flat donut. At least one side of the adhesive barrier is an adhesive surface protected by a peel-off cover or liner.

In an embodiment, the adhesive barrier is assembled into a frusto-conical shape by first removing the peel-off liner, and using the adhesive surface to stick a first edge of the adhesive barrier to the bottom surface of a second edge of the adhesive barrier. Upon assembly, the adhesive barrier forms a self-standing cone with a large opening at one end, and a smaller opening at another end.

In a preferred embodiment, the adhesive barrier is assembled around the base of a plant, or around the base of a leg of a piece of furniture, for example, to form a cone-shaped adhesive barrier to protect the plant or the piece of furniture.

In this respect, before explaining at least one embodiment of the invention in detail, it is to be understood that the invention is not limited in its applications to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows an illustrative example of an adhesive barrier comprising two semi-arcs attached at a foldable edge.

FIG. 2 shows the adhesive barrier of FIG. 1 laid inside the base of an insect trap.

FIG. 3 shows the adhesive barrier of FIG. 1 folded in half.

FIG. 4 shows one-half of the adhesive barrier of FIG. 1, with a peel-off liner partially removed.

FIG. 5 shows the adhesive barrier of FIG. 4 with the peel-off liner entirely removed.

FIG. 6 shows a top view the adhesive barrier of FIG. 5 with the first and second edges of the adhesive barrier bonded together to form a cone shape.

FIG. 7. shows a side perspective view of the cone-shaped adhesive barrier of FIG. 6.

FIG. 8 shows a side perspective view of the cone-shaped adhesive barrier of FIG. 6 placed on the base of an insect trap.

FIG. 9 shows a side perspective view of the cone-shaped adhesive barrier of FIG. 6 with the larger opening oriented upwards.

FIG. 10 shows a side perspective view of a cone-shaped adhesive barrier with an adhesive surface provided on the inside surface of the cone.

### DETAILED DESCRIPTION

As noted above, the present invention relates to an adhesive barrier for crawling insects, which can be set up to be self-standing without any additional apparatus.

In an embodiment, the adhesive barrier is a flexible sheet of material with an adhesive on at least one side. The flexible sheet of material may be formed into a partial band or ring shape forming an arc. For example, the shape may be described as half of a flat donut. At least one side of the adhesive barrier is an adhesive surface protected by a peel-off cover or liner.

The adhesive barrier can be assembled into a frusto-conical shape by first removing the peel-off liner, and using the adhesive surface to stick a first edge of the adhesive barrier to the bottom surface of a second edge of the adhesive barrier. Upon assembly, the adhesive barrier forms a self-standing cone with a large opening at one end, and a smaller opening at another end.

In use, the adhesive barrier is assembled around the base of a plant, or around the base of a leg of a piece of furniture, for example, to form a cone-shaped adhesive barrier to protect the plant or the piece of furniture.

An illustrative embodiment will now be described in detail with reference to the drawings.

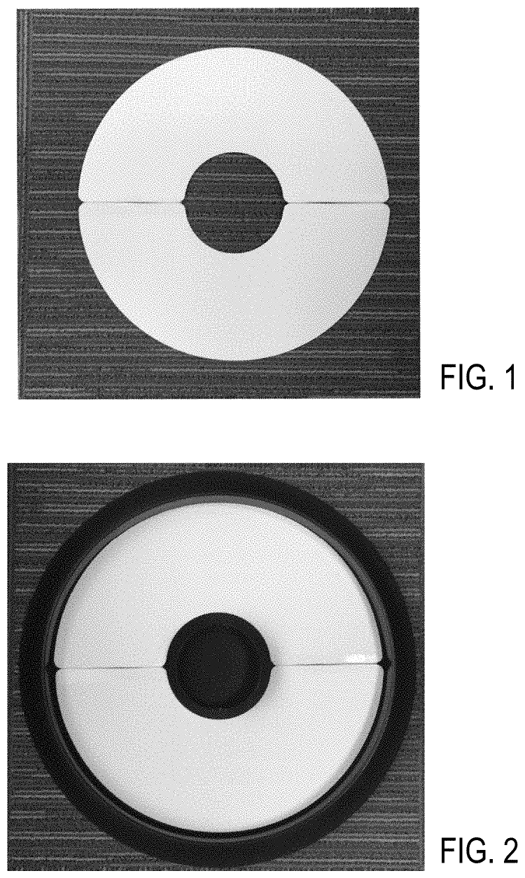

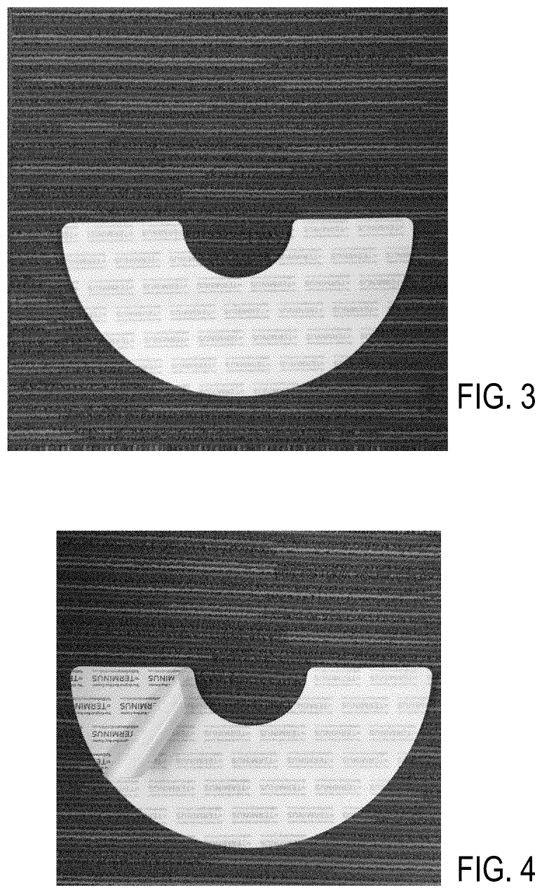

FIG. 1 shows an illustrative example of an adhesive barrier comprising two semi-arcs attached at a foldable edge. The adhesive barrier may be used in this configuration when inserted into an insect trap apparatus, such as shown in FIG. 3 by way of example.

FIG. 2 shows the adhesive barrier of FIG. 1 laid inside the base of an insect trap. When used in this manner, the adhesive side is placed upwards, and the two semi-arcs form a complete ring or donut shape, thereby providing an adhesive barrier for any crawling insects that may attempt to traverse the gap from outside the ring to the center.

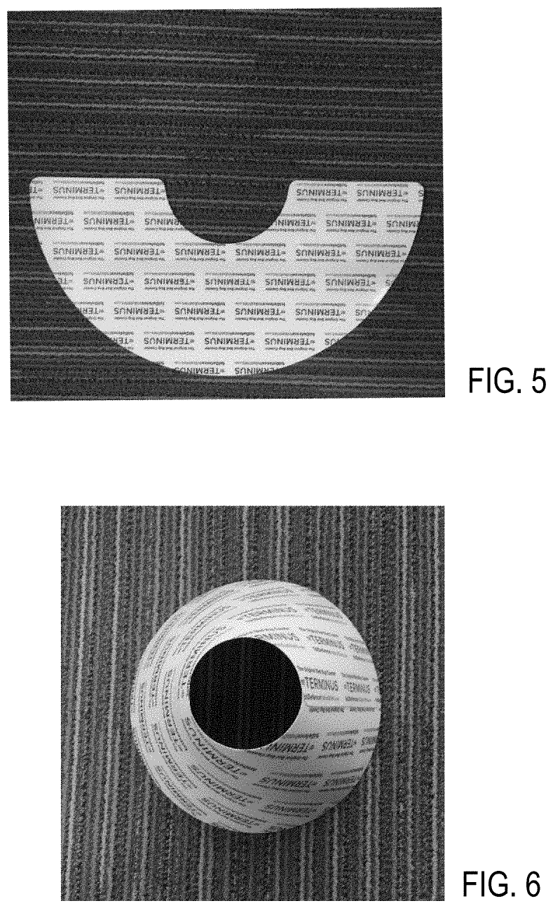

FIG. 3 shows the adhesive barrier of FIG. 1 folded in half, with the adhesive side protected by a peel-off cover or liner. The shape of this adhesive barrier forms half of a circular ring, or donut shape. FIG. 4 shows one-half of the adhesive barrier of FIG. 1, with a peel-off liner partially removed. FIG. 5 shows the one-half of the adhesive barrier of FIG. 1, with the peel-off liner fully removed. The semicircular cut-out in the center of the straight side may be of varying size, but should accommodate whatever is to be protected when first and second edges of the adhesive barrier are bonded together.

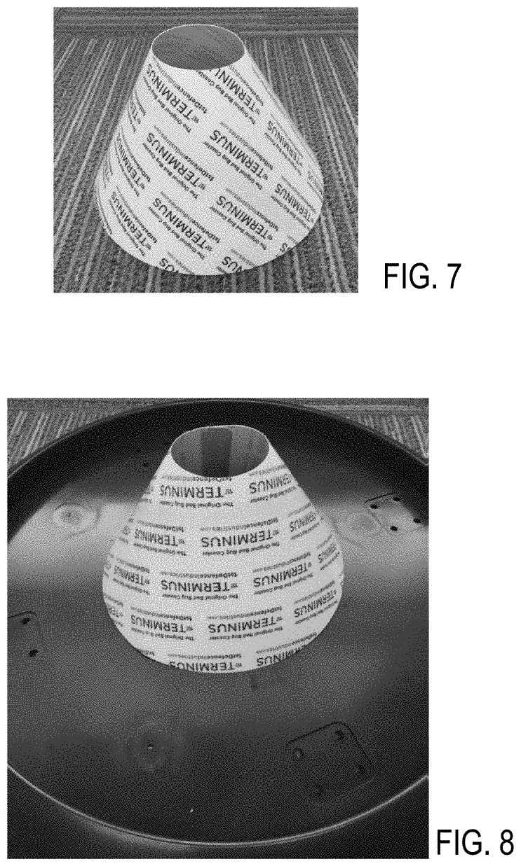

FIG. 6 shows a top view the adhesive barrier of FIG. 5 with the first and second edges of the adhesive barrier bonded together to form a cone shape. As at least one surface of the adhesive barrier is sticky, either edge of the semi-arc may be placed on the opposite edge with a sufficient overlap to allow the two edges to be bonded together by the adhesive surface. FIG. 7. shows a side perspective view of the cone-shaped adhesive barrier of FIG. 6, exposing the adhesive surface around the entire outer surface of the cone. This effectively forms a self-standing insect barrier which traps any crawling insects attempting to scale its outer wall.

FIG. 8 shows a side perspective view of the cone-shaped adhesive barrier of FIG. 6 placed on the base of an insect trap, and shows that the bottom edge of the cone-shaped adhesive barrier provides direct contact with the surface on which it is placed, thus preventing insects from crawling under the bottom of the cone. However, to provide greater security, the bottom of the cone may be provided with an additional layer of adhesive along its edge, in order to allow the cone-shaped adhesive barrier to stick to the surface on which it is placed.

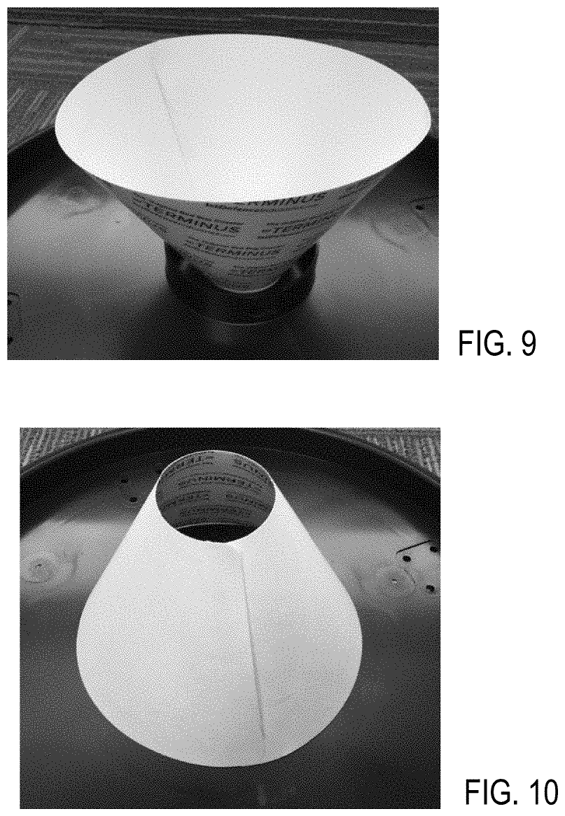

FIG. 9 shows a side perspective view of the cone-shaped adhesive barrier of FIG. 6 with the larger opening oriented upwards. In this configuration, the smaller opening of the cone-shaped it is a barrier is placed at the bottom when, for example, the amount of space available for installing the adhesive barrier is limited. In this orientation, the cone-shaped insect barrier is also effective in preventing crawling insects that attempt to scale its outer surface.

FIG. 10 shows a side perspective view of a cone-shaped adhesive barrier with an adhesive surface provided on the inside surface of the cone. In this configuration, the cone-shaped insect barrier prevents crawling insects from scaling its inner wall.

In another embodiment, an adhesive surface may be provided on both sides of the cone-shaped insect barrier, such that insects attempting to access a protected item are traps on either surface.

As will be appreciated, the adhesive barrier need not be in the shape of a cone, but may form other shapes when it's two side edges are bonded together. By way of example, and not by way of limitation, the adhesive barrier may form the shape of a four sided pyramid, with angled sides and a square opening formed at the top. The number of flat surfaces may be determined by the particular item being protected, such that the top opening fits snugly around the item (e.g. a leg of a piece of furniture) to prevent any crawling insects from getting past the adhesive barrier from the inside.

Thus, in an aspect, there is provided an adhesive barrier for crawling insects, comprising: a flexible sheet of material having an adhesive on at least one side, with a peel-off liner protecting the adhesive surface; wherein, in use, the flexible sheet of material is shaped to form a self-standing adhesive barrier when its first and second side edges are overlapped and bonded together, the self-standing barrier having angled side walls and first and second openings of a different size, at least one of the first and second openings adapted to be placed on a flat surface without any gaps.

In an embodiment, the flexible sheet of material is formed into a partial band or ring shape forming an arc.

In another embodiment, in use, the flexible sheet of material is formed into a frusto-conical shape, with an adhesive on at least one of the inner and outer surfaces of the frusto-conical shape.

In another embodiment, in use, the flexible sheet of material is formed into a self-standing cone with a large opening at one end, and a smaller opening at another end.

In another embodiment, in use, the self-standing cone is placed with the larger opening at a bottom end.

In another embodiment, in use, the self-standing cone is placed with the larger opening at a top end.

In another embodiment, in use, the self-standing cone is placed with the larger opening at a bottom end.

In another embodiment, in use, the self-standing cone has an adhesive on an outer surface of the cone.

In another embodiment, in use, the self-standing cone has an adhesive on an inner surface of the cone.

In another embodiment, in use, the self-standing cone has an adhesive on both inner and outer surfaces of the cone.

Various changes and modifications may be made without departing from the scope of the invention, which is defined by the following claims.

1. An adhesive barrier for crawling insects, comprising:
a flexible sheet of material having an adhesive on at least one side, with a peel-off liner protecting the adhesive surface;
wherein, in use, the flexible sheet of material is shaped to form a self-standing adhesive barrier when its first and second side edges are overlapped and bonded together, the self-standing barrier having angled side walls and first and second openings of a different size, at least one of the first and second openings adapted to be placed on a flat surface without any gaps.

2. The adhesive barrier of claim 1, wherein the flexible sheet of material is formed into a partial band or ring shape forming an arc.

3. The adhesive barrier of claim 2, wherein the flexible sheet of material is formed into a frusto-conical shape, with an adhesive on at least one of the inner and outer surfaces of the frusto-conical shape.

4. The adhesive barrier of claim 2, wherein the flexible sheet of material is formed into a self-standing cone with a large opening at one end, and a smaller opening at another end.

5. The adhesive barrier of claim 4, wherein, in use, the self-standing cone is placed with the larger opening at a bottom end.

6. The adhesive barrier of claim 4, wherein, in use, the self-standing cone is placed with the larger opening at a top end.

7. The adhesive barrier of claim 4, wherein, in use, the self-standing cone is placed with the larger opening at a bottom end.

8. The adhesive barrier of claim 4, wherein, in use, the self-standing cone has an adhesive on an outer surface of the cone.

9. The adhesive barrier of claim 4, wherein, in use, the self-standing cone has an adhesive on an inner surface of the cone.

10. The adhesive barrier of claim 4, wherein, in use, the self-standing cone has an adhesive on both inner and outer surfaces of the cone.
